(19) United States
(12) Patent Application Publication
(10) Pub. No.: US 2023/0046041 A1
(43) Pub. Date: Feb. 16, 2023

(54) System and Method for the Capture of CO2 and Nitrogen in a Gas Stream

(71) Applicant: CAPTICO2 RIGHTS AS, BERGEN (NO)

(72) Inventor: Oddvar SPJELD, Ågotnes (NO)

(21) Appl. No.: 17/793,101

(22) PCT Filed: Jan. 25, 2021
(86) PCT No.: PCT/NO2021/050019

§ 371 Date: Jul. 15, 2022

(30) Foreign Application Priority Data
Jan. 23, 2020 (NO) 20200087

(51) Int. Cl. F25J 1/00

(52) U.S. Cl. CPC F25J 1/0027

(57) ABSTRACT

There is provided a nitrogen rejection unit for extracting nitrogen and carbon dioxide from a flue gas, the system comprising: a first container for holding a first volume of the flue gas at a first pressure and a first temperature that is below or equal to the condensation temperature of the carbon dioxide and greater than the condensation temperature of nitrogen; an outlet for removing the carbon dioxide as a liquid from the first container; means for transporting gaseous nitrogen from the first container to a second container and means for cooling the nitrogen such that the second container contains nitrogen at a second temperature that is below or equal to its condensation temperature such that at least some of the nitrogen in the second container is in liquid form; and means for guiding the liquid nitrogen from the second container through or around the first container to cool the material within the first container to the first temperature. There is also provided a system for capturing carbon dioxide in a flue gas, a method for extracting nitrogen from a flue gas, and a method for capturing carbon dioxide in a flue gas.

The present invention relates to a system for removal of CO₂ from flue gas, and in particular from any fossil fuel burning motor or plant. The invention can be used in particular for removal via mineralization of CO₂ from flue gas produced in a power plant.

Over the past several decades in particular, there has been increasing focus on the issue of global warming caused by carbon dioxide entering the atmosphere as a result of human activities. One of the main contributors to anthropogenic atmospheric carbon dioxide is electricity producing power plants, which burn fossil fuels. Alternative, cleaner, sources of energy such as wind, solar, or hydro are being investigated throughout the world and are now beginning to be widely implemented. It is arguable, however, that such means must be supplemented with other solutions if catastrophic warming is to be prevented. To this end, substantive research has been carried out on methods for the capture the carbon dioxide produced as an exhaust gas in power plants, as well as means of increasing the efficiency of combustion to reduce the level of carbon dioxide produced initially.

Power plants produce electricity via the combustion of fuels such as coal, petroleum, natural gas, biofuel, and coke. Heat generated by the combustion is used to create steam which drives a turbine to produce electricity. Burning natural gas as fuel, rather than coal, can help to reduce the level of pollutants in the resulting exhaust gas, however the levels are still high, which is clearly of concern.

Post-combustion solutions can be divided into those which capture carbon dioxide for storage underground, either in geological structures or in oil wells which have been drained of oil and lie empty, and those which use the carbon dioxide to produce stable products which can then be reused. The first solution is known as Carbon Capture and Storage (CCS) and the second as Carbon Capture and Utilization (CCU). Both are valuable, however storage of carbon dioxide in geological structures such as empty oil wells does run the risk of leakage, and this will of course result in the release of carbon dioxide into the atmosphere which the method aims to prevent. CCU, by contrast, can provide benefits in that by-products of the capture process are commercially valuable and can help to recoup some of the cost of including carbon capture processes in a plant.

Various chemical processes can convert carbon dioxide into alternative substances. One known method is to use an alkaline brine through which carbon dioxide is bubbled, resulting in the mineralization of the carbon dioxide to form a carbonate. If calcium ions are present in the brine, then calcium carbonate will be a product of the reactions occurring within the reactor. The carbon dioxide is therefore converted into an inert form rather than being released into the atmosphere.

In order to effectively fix carbon dioxide in this way, it is necessary to first separate out the various other elements of the flue gas. The table below outlines the composition of flue gas in a typical case. The substances making up the flue gas include dust and ash, as well as sulphur dioxide, methane, and nitrogen.

Typical Flue Gas Composition

| Substance | Vol % |
|---|---|
| N₂ | 65-66% |
| H₂O | 20-23% |
| CO₂ | 10-11% |
| O₂ | 4-5% |
| SO₂ | <1% |
| NOₓ | <1% |
| CO | <1% |
| N₂O | <1% |
| CH₄ | <1% |

Filters are often used in order to remove components such as dust and ash from the flue gas. Gaseous elements can be separated using cryogenic distillation (liquification of some substances within the gas by cooling). Sulphur oxides (such as sulphur dioxide) can be removed from the flue gas via a process referred to as “wet scrubbing” or wet flue gas desulphurization. Here, a slurry containing absorbent, either in solution or in suspension, is sprayed into the flue gas within a chamber so that elements of the slurry react with the sulphur. Components forming the slurry need to be sourced and transported to the power plant which of course adds to running costs. Dry processes for desulphurization can also be used, however these tend to be less efficient.

The below description focusses on the mineralization of carbon dioxide by bubbling it through an alkaline brine to convert it into an inert substance. Here, a reaction with metal cations takes place after hydrogenation of the carbon dioxide in order to form carbonates. If calcium cations are present, then calcium-based carbonates will be formed. If magnesium or iron cations are present, then magnesium or iron-based carbonates will be formed, and so on. The cations used will depend on what the desired final product of the reaction. Calcium carbonate slurry, which is a product of the reaction with calcium ions, can be dried to form calcium carbonate. The calcium carbonate is used widely and so calcium cations in solution will generally be a good choice, but any metal cation or combinations of metal cation can be used.

The reduction of carbon dioxide emissions is extremely beneficial to a company running a power plant, both in terms of the effect on the environment and because of the high levels of tax payable by companies on emissions. A problem with using this type of ex-situ mineralization for the conversion of carbon dioxide is that the reaction rate of the hydrogenation is slow, increasing running costs to impractical levels. There is therefore a balance to be struck between these factors if the plant is to be cost-effective. U.S. Pat. No. 9,789,439 (hereafter Siller) describes the use of solid metal materials (and in particular of nickel nanoparticles) to increase the rate of hydration of carbon dioxide prior to reaction with the metal cations in solution. Application of this technology to the carbon fixing process can greatly reduce the cost of implementation.

Carbon capture can reduce carbon dioxide production in a power plant fairly effectively, and the use of solid metal catalysts can reduce the cost of applying such techniques. These methods are, however, still expensive because of the requirement of additional equipment required to pump or heat and cool the different components. Improvements in the efficiency of such processes are desired.

According to a first aspect of the present invention, there is provided a nitrogen rejection unit for extracting nitrogen and carbon dioxide from a material, the system comprising: a first housing comprising a first chamber for holding a first volume of the material at a first pressure and a first temperature that is below or equal to the condensation temperature of the carbon dioxide at the first pressure and greater than the condensation temperature of nitrogen; an outlet for removing the carbon dioxide as a liquid from the first chamber of the first housing and an a pathway for gaseous nitrogen to pass into a second chamber of the first housing; means for transporting nitrogen from the first housing to a second housing, wherein the second housing holds the nitrogen at a second temperature that is below or equal to the condensation temperature of nitrogen; and a conduit for guiding liquid nitrogen from the second housing through and/or around the first housing to cool the material within the first housing to the first temperature. The means for transporting nitrogen may be active or passive, or active for a part of the route and passive for another part. The material may be a gas, such as an exhaust gas from a power plant. This method for cooling material within the first housing is particularly advantageous in that it not only recycles the nitrogen gas produced by the process, but it allows for careful control of the temperatures within the first housing by regulating flow rate of the liquid nitrogen.

The material within the first housing to be cooled to the first temperature may be gas or gaseous material. Methane and oxygen may also be removed as liquids from the first housing. Nitrogen may be transported from the first to the second housing as a liquid. The system therefore re-uses nitrogen present in the flue gas, once it has been cooled down so that it is converted to liquid form, as a coolant to distill CO₂ and other components in the flue gas to liquid form. This greatly improves the efficiency of the whole system. Cooling of the gaseous nitrogen to the second temperature may be by way of a turboexpander in which the gas expands to reduce the pressure and consequently decrease the temperature.

In embodiments, the gaseous nitrogen expands as it passes from the first housing to the second housing such that material in the second housing is at a second pressure that is lower than the first pressure. The expansion of the gaseous nitrogen may also be the means for cooling the gaseous nitrogen, and may be the only or one of a number of means for cooling the gaseous nitrogen. The means for cooling the gaseous nitrogen may be a turboexpander.

In embodiments, energy from the expansion of the gaseous nitrogen as it passes from the first housing to the second housing is used to compress the gas entering the first housing. This is generally achieved using a turboexpander, and specifically a cryogenic turboexpander. A much more energy efficient, and potentially compact, system is provided.

In embodiments, energy from the expansion of the gaseous nitrogen as it passes from the first housing to the second housing is used to compress the gas entering the first housing.

In embodiments, the gaseous nitrogen passes through an expansion turbine as it passes from the first housing to the second housing, and the expansion turbine is configured to drive a compressor for compressing the first volume of the flue gas to the first pressure.

In embodiments, liquid nitrogen flows from the second housing through the first housing along a pipe that forms a tortuous path and then back to the second housing. This shape of the pipe increases the surface area for heat exchange.

In embodiments, the nitrogen rejection unit comprises a condensing heat exchanger for heating and drying the gas entering the system.

In embodiments, the nitrogen rejection unit comprises a combination of tube heat exchangers to liquify the components of the flue gas and mesh-pads to stop liquid from entering into the next distillation column.

In embodiments, the material within the first housing is held at a pressure of between 50 bar and 200 bar, preferably between 100 bar and 200 bar, and preferably around 150 bar and the material within the second housing is held at a pressure of between 5 bar and 100 bar, preferably between 25 bar and 75 bar, and most preferably around 50 bar.

In embodiments, the material within the second housing is cooled to a temperature of around −196° C., so that the second temperature is −196° C.

In embodiments, the first housing comprises at least two cooling chambers and the material within the first housing is cooled to the first temperature in the first chamber and to a lower temperature in the second chamber.

In embodiments, the first housing comprises four cooling chambers and the material within the first housing is cooled to the first temperature in the first chamber, to a third temperature that is between the first temperature and the second temperature in the second chamber, and to a fourth temperature that is between the third temperature and the second temperature in the third chamber, and to a fifth temperature that is between the fourth temperature and the second temperature in a fourth chamber.

In embodiments, the first temperature is 10° C., the third temperature is −85° C., the fourth temperature is −125° C., and the fifth temperature is −150° C., and wherein CO₂ is removed as liquid from the first chamber of the first housing, methane is removed as a liquid from the second chamber, oxygen is removed as a liquid from the third chamber, and the nitrogen is transported as a liquid from the fourth chamber to the second housing. The second temperature (of the second housing) may be between −170° C. and −220° C., preferably between −190° C. and −200° C., and most preferably around −196° C.

Carbon dioxide can therefore be distilled out in the first chamber, methane in the second chamber, oxygen in the third chamber, and nitrogen in the fourth chamber. The temperature to which the material is cooled may be between 20° C. and −40° C., preferably between 15° C. and 5° C. in the first chamber, between −82.6° C. and −90° C. in the second chamber, between −118.6° C. and −130° C. in the third chamber, and between −147° C. and −160° C. in the fourth chamber.

In embodiments, each cooling chamber is provided with a separate cooling system comprising an outlet for liquid nitrogen from the second housing, one or more conduits for liquid nitrogen to flow in and/or around the chamber. These separate cooling systems can be separately controlled to ensure that the temperatures in each cooling chamber are kept at the optimum levels. Each of these cooling systems or mechanisms still uses liquid nitrogen originating in the flue gas itself, which is extremely efficient.

In embodiments, each cooling system comprises an inlet for liquid nitrogen to flow from the one or more conduits back to the second housing, a thermometer for measuring a temperature of the material within the chamber, and a pump for moving fluid from the outlet, through the one or more conduits, and back to the inlet, wherein the action of the pump is controlled based on the measured temperature to maintain the temperature of material within the chamber within a pre-determined range of temperatures. Use of a temperature sensor in combination with a pump and a feedback mechanism is a simple and effective way to provide separate control of the temperature within the different chambers.

According to a second aspect of the present invention, there is provided a system for capturing carbon dioxide in a flue gas, the system comprising: a desulphurization unit for removing sulphur dioxide from the flue gas; a nitrogen rejection unit of the first aspect; a reactor unit containing an alkaline brine and a catalyst and having an inlet for receiving carbon dioxide from the nitrogen rejection unit for the reaction of the carbon dioxide to form a carbonate slurry.

In embodiments, the desulphurization unit is configured to receive at least a portion of the carbonate slurry produced in the reactor unit for use in wet scrubbing of the flue gas to remove the sulphur dioxide.

In embodiments, the system comprises a brine feed tank configured to receive and mix the constituents of the alkaline brine with the catalyst before transport to the reactor unit.

In embodiments, the system comprises a condensing heat exchanger configured to remove waste water from the flue gas before it enters the nitrogen rejection unit, wherein the system comprises means to transport the waste water to the brine feed tank.

In embodiments, the system comprises means for extracting water from at least a portion of the calcium carbonate slurry produced in the reactor unit and to transport the extracted water to the brine feed tank for mixing.

In embodiments, the system comprises one or more filters for removing ash and NOₓ from the flue gas before it enters the desulphurization unit.

According to a third aspect of the present invention, there is provided a method for extracting nitrogen from a gas comprising nitrogen and carbon dioxide, the method comprising: compressing, using a compressor, a volume of the gas to a first pressure, transferring the volume of gas to a first chamber of a first housing, and cooling it to a first temperature that is below or equal to the condensation temperature of carbon dioxide and greater than the condensation temperature of nitrogen; removing the carbon dioxide as a liquid from the first chamber; allowing the nitrogen to pass as a gas from the first chamber to a second chamber of the first housing; transporting nitrogen from the first housing to a second housing where it is at a second pressure and a second temperature which is below the condensation temperature of nitrogen at the second pressure; removing liquid nitrogen from the second housing and passing at least some of the liquid nitrogen from the second housing through or around the first housing to cool the material therein. The first volume may be enclosed within a first housing and the second volume within a second, separate, housing.

In embodiments, the liquid nitrogen is passed from the first housing to the second housing through an expansion turbine such that it reaches a second pressure that is lower than the first pressure, and wherein the expansion turbine is used to partially drive the compressor. This is another novel feature of the invention.

According to a fourth aspect of the present invention, there is provided a method for capturing carbon dioxide in a flue gas, the method comprising: removing sulphur dioxide from the flue gas in a desulphurization unit; separating nitrogen and carbon dioxide from the flue gas using the method of the third aspect; transporting the extracted carbon dioxide to a reactor unit containing an alkaline brine; and converting the carbon dioxide in the reactor unit to a carbonate.

According to a fifth aspect of the present invention, there is provided a method for capturing carbon dioxide in flue gas, the method comprising: removing sulphur dioxide from the flue gas by wet scrubbing in a desulphurization unit; removing nitrogen from the flue gas in a nitrogen rejection unit and separating carbon dioxide from the flue gas for input into a reactor unit with an alkaline brine and a solid metal catalyst; mineralizing the carbon dioxide in the reactor unit to form a carbonate slurry, wherein the initial hydrogenation of the carbon dioxide is catalyzed by the solid metal catalyst; and transporting at least some of the carbonate slurry to the desulphurization unit for use in wet scrubbing of the flue gas to remove the sulphur dioxide.

In embodiments, the solid metal catalyst comprises nickel nanoparticles. In embodiments, calcium is added to the alkaline brine and the carbonate slurry produced is calcium carbonate slurry.

According to a first example, there is provided a nitrogen rejection unit for extracting nitrogen and carbon dioxide from a gas, the system comprising: a first housing for holding a first volume of the gas at a first pressure and a first temperature that is below or equal to the condensation temperature of the carbon dioxide and greater than the condensation temperature of nitrogen; an outlet for removing the carbon dioxide as a liquid from the first housing; means for transporting gaseous nitrogen from the first housing to a second housing and means for cooling the nitrogen such that the second housing holds nitrogen at a second temperature that is below or equal to the condensation temperature of nitrogen; and means for guiding liquid nitrogen from the second housing through or around the first housing to cool the material within the first housing to the first temperature.

In examples, the gaseous nitrogen expands as it passes from the first housing to the second housing such that material in the second housing is at a second pressure that is higher than the first pressure. In examples, energy from the expansion of the gaseous nitrogen as it passes from the first housing to the second housing is used to compress the first volume of gas entering the first housing.

In examples, the gaseous nitrogen passes through an expansion turbine as it passes from the first housing to the second housing, and the expansion turbine is configured to drive a compressor for compressing the first volume of the gas to the first pressure.

In examples, liquid nitrogen is flows from the second housing through the first housing along a pipe that forms a tortuous path and then back to the second housing.

In examples, the system comprises a compressing heat exchanger for heating and drying the gas entering the system. In examples, the material within the first housing is held at a pressure of around 15 bar and the material within the second housing is held at a pressure of around 5 bar.

In examples, the material within the second housing is cooled to a temperature of around −196° C. In examples, the material within the first housing is cooled to a temperature of around −185° C.

According to a second example, there is provided a method for extracting nitrogen from a gas comprising nitrogen and carbon dioxide, the method comprising: compressing, using a compressor, a volume of the gas to a first pressure and cooling it to a first temperature that is below or equal to the condensation temperature of carbon dioxide and greater than the condensation temperature of nitrogen and transferring the volume of gas to a first housing; removing the carbon dioxide as a liquid from the first housing; passing the nitrogen from the first housing to a second housing and cooling it to a second temperature that is below or equal to the condensation temperature of nitrogen; removing liquid nitrogen from the second housing and passing at least some of the liquid nitrogen from the second housing through or around the first housing to cool the material therein.

In examples, the nitrogen is passed from the first housing to the second housing through an expansion turbine such that it reaches a second pressure that is higher than the first pressure, and wherein the expansion turbine is used to drive the compressor.

In a third example, there is provided a method for capturing carbon dioxide in a flue gas, the method comprising: removing sulphur dioxide from the flue gas in a desulphurization unit; separating nitrogen and carbon dioxide from the flue gas using the method of the second example; transporting the extracted carbon dioxide to a reactor unit containing an alkaline brine; and converting the carbon dioxide in the reactor unit to a carbonate.

Embodiments of the present invention will now be described, by way of example only, with reference to the following diagrams wherein:

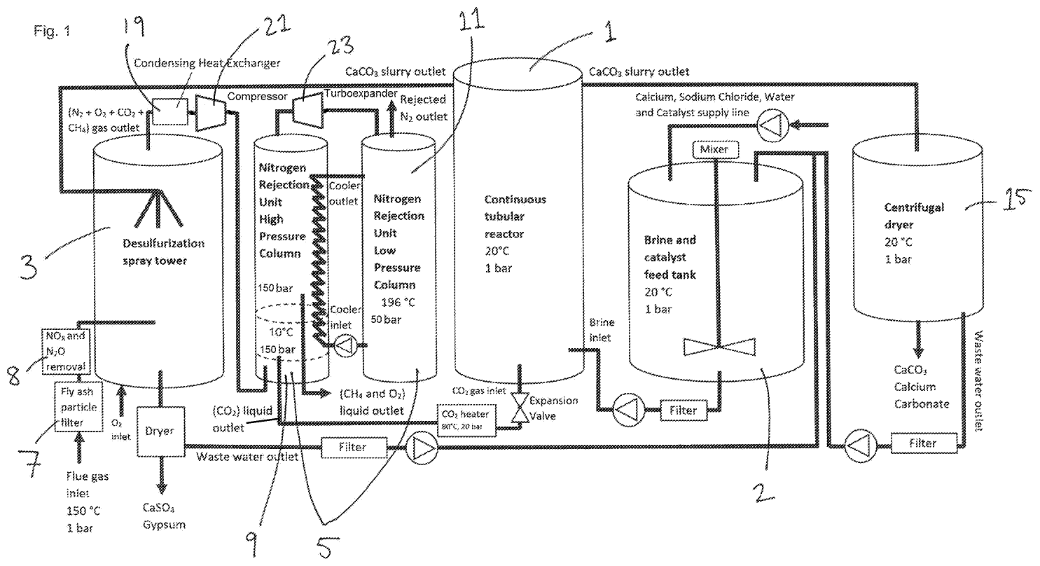

FIG. 1 shows a diagram of a carbon dioxide removal system;

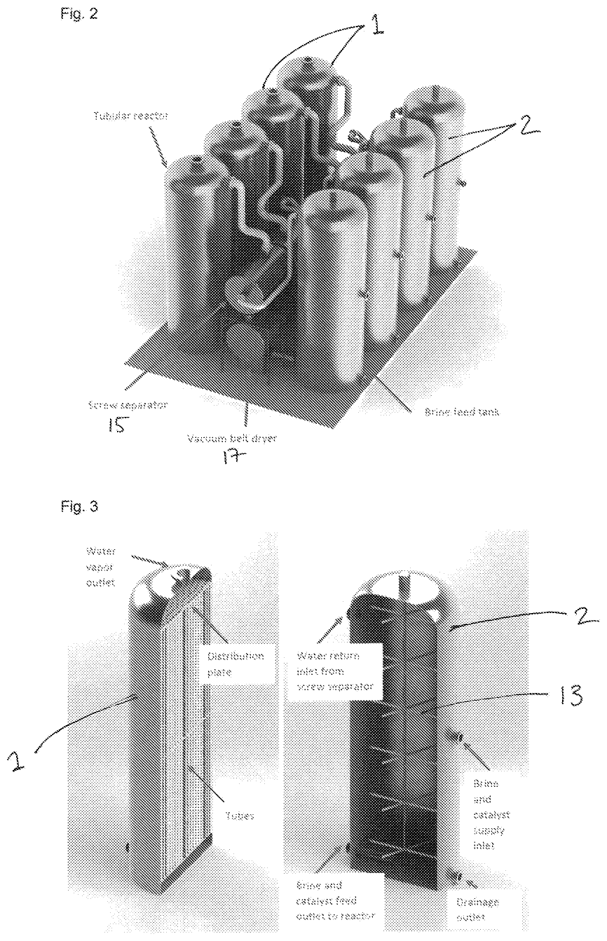

FIG. 2 shows a perspective view of a removal system, including reactor tanks and brine feed tanks;

FIG. 3 shows cross-sectional views of a reactor (left) and a brine feed tank with mixer (right);

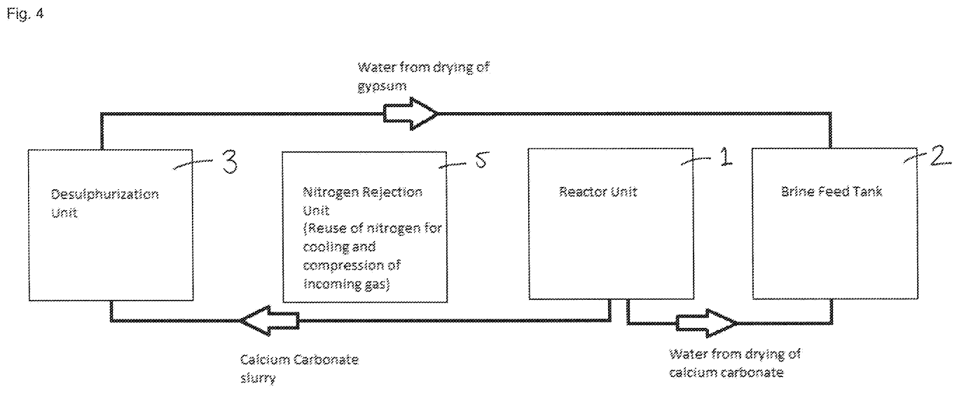

FIG. 4 is a flow-chart illustrating the re-use of products in the system;

FIG. 5 shows some of the components of a nitrogen rejection unit;

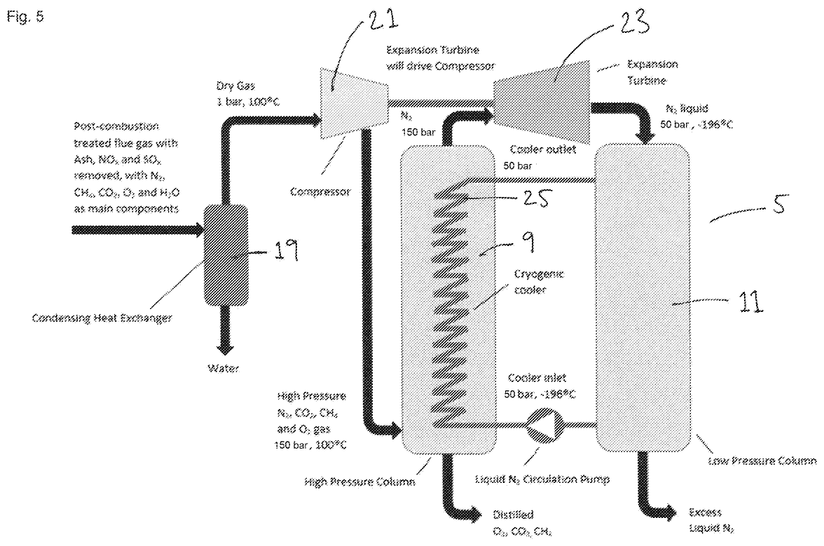

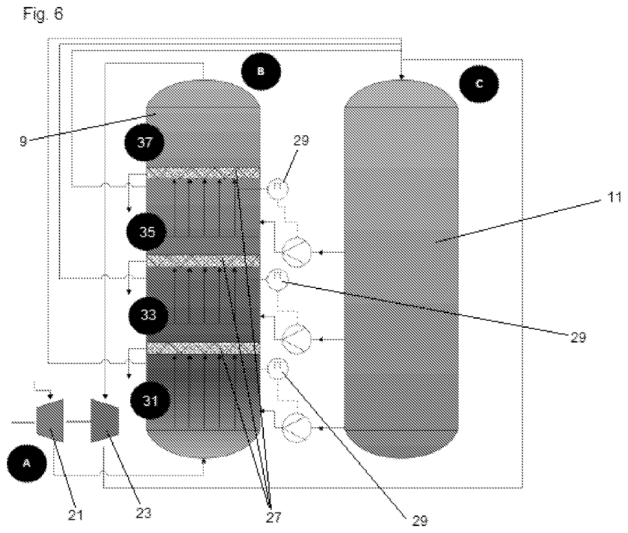

FIG. 6 shows components of the nitrogen rejection unit in more detail;

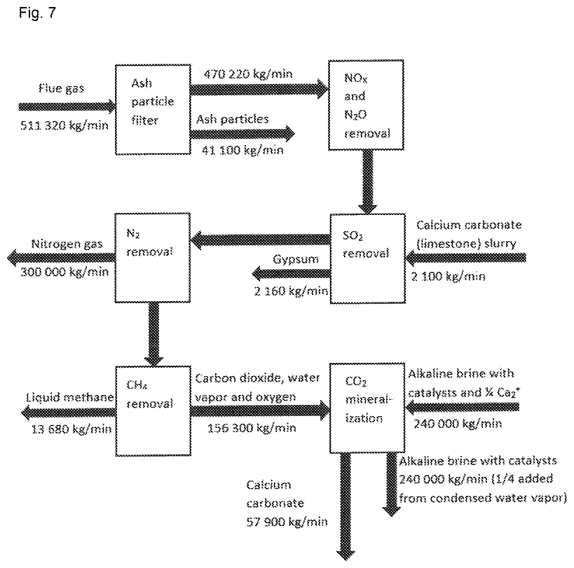

FIG. 7 is a flow chart illustrating the mass balance of the carbon capture process;

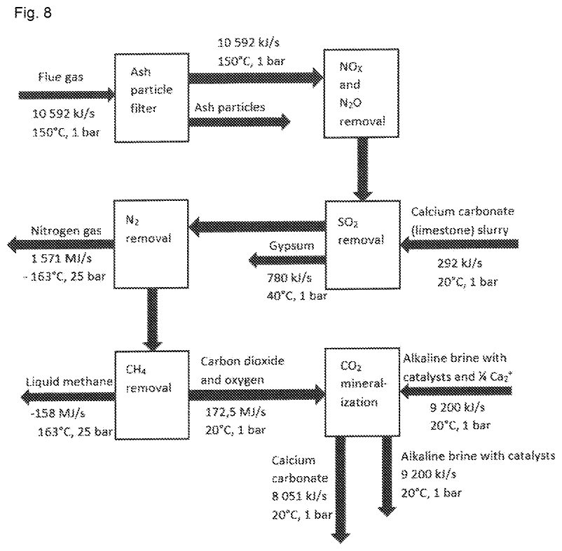

FIG. 8 is a flow chart illustrating the energy balance for the carbon capture process.

FIG. 1 illustrates a system for the removal of carbon dioxide from flue gas including the various units or sub-systems coupled together to form the larger apparatus. Units refer to the smaller parts of the whole, including each of the desulphurization unit 3 (which may be a spray tower as shown in the figure), the reactor unit 1 (which may be a continuous tubular reactor), the nitrogen rejection unit 5, and the brine feed tank 2. Flue gas enters the desulphurization unit 3 through one or more filters 7 which act to remove particulates such as fly ash. These filters may be electrostatic precipitator filters. Also prior to entering the spray tower in a further sub-system indicated as numeral 8 in the figure (or less preferably within the tower) the gas may undergo a selective catalytic reduction reaction using ammonia to remove NOx from the gas in the following reaction:

4NO_{X} (g)+4NH₃ (l)+O₂ (g)→4N₂ (g)+6H₂O (l)

Before, after, or concurrently with the above reaction proceeding (also within subsystem 8), removal of N₂O may be carried out in another selective catalytic reduction reaction, this time using methane in the following reaction:

2N₂O (g)+CH₄ (g)→2N₂ (g)+CO₂ (g)+2H₂ (g)

The methane may be already present within the flue gas, may be redirected from the output of the high-pressure column of the nitrogen rejection unit 5 (see below), or may be sourced externally.

Within the spray tower 3, sulphur dioxide is removed from the gas via a wet scrubbing process using calcium carbonate slurry. Elements of the calcium carbonate slurry in the form of droplets react with the SO₂ resulting in the production of CaSO₄2H₂O (gypsum slurry) in the following reactions:

SO₂ (g)+CaCO₃ 0.5H₂O (l)→CaSO₃ 0.5H₂O (l)+CO₂ (g)

CaSO₃ 0.5H₂O (l)+0.5 O₂ (g)+1.5H₂O (l)→CaSO₄ 2H₂O

The gypsum slurry which produced as output from the desulphurization unit 3 is dried to produce commercial grade gypsum which is then transported from the plant for sale and/or use. Water extracted during the drying process can be filtered and reused within the system as will be described in more detail below.

Flue gas with SO₂ removed passes through a condensing heat exchanger to remove water vapor before it is pressurized to 150 bar and fed into a two-column nitrogen rejection unit 5 comprising each of a high-pressure column 9 and low-pressure column 11. Here, nitrogen is separated off from the rest of the gas by cooling the gas to liquify carbon dioxide, methane, oxygen, and usually also nitrogen, in turn. The pressurized liquid nitrogen is fed into a turboexpander to depressurize the nitrogen from 150 bar to 50 bar. If the temperature to which chamber 37 is cooled is less than −147° C., or if the pressure of the first housing is lower than 150 bar, then the nitrogen may leave the first housing as gaseous nitrogen and liquify as it expands and cools. Cooling the nitrogen to a liquid in the first housing and passing it through the expansion turbine as a liquid is, however, more efficient. The high-pressure liquid nitrogen (or in some cases gaseous nitrogen) propels a turbine in a non-combustion process which in turn drives the compressor used to pressurize the flue gas from 1 bar to 150 bar before it is fed into the high-pressure column. The above features make the nitrogen rejection unit particularly energy efficient to operate.

Another novel feature of the invention is that the cooling system using liquid nitrogen may be a closed loop in the sense that all of the liquid nitrogen within the system is directed from the low-pressure housing and around or through the high-pressure housing as a coolant, before being directed back again to the low-pressure housing. Since more nitrogen from the flue gas entering the system is being introduced continuously, however, there will usually be an outlet for excess nitrogen or liquid nitrogen within the system. This excess can be stored and potentially used in the system at a later stage, can be stored for other uses, or can simply be ejected from the system.

Details of the nitrogen rejection unit 5 are provided below. Because the nitrogen rejection unit works by cooling the gas until carbon dioxide, methane, and oxygen become liquid, these other components of the flue gas can be separated from the nitrogen and removed as liquid from the unit. Liquid methane is useful as a biofuel additive, for example, and can be stored or transported to this end. Usually, phase changes occurring in the high-pressure column of the nitrogen rejection unit are as follows:

N₂ (g)+O₂ (g)+CO₂ (g)+CH₄ (g)→N₂ (l)+O₂ (l)+CO₂ (l)+CH₄ (l)

The following table lists condensation temperatures for some components of the flue gas. The condensation temperatures at atmospheric and 150 bar are listed. CO₂ cannot be in its liquid form at atmospheric pressure.

| | Condensation | Condensation |
|---|---|---|
| Constituent | Temperature (° C.) at | Temperature |
| of the Flue Gas | atmospheric pressure | (° C.) at 150 bar |
| Nitrogen | −196 | −147 |
| Carbon Dioxide | −56.6 | 31 |
| Methane | −162 | −82.6 |
| Oxygen | −182.96 (~−183) | −118.6 |

Methane, oxygen, carbon dioxide, and usually also nitrogen, are liquified by using liquid nitrogen as a coolant in a multi-stage cooler in the high-pressure column 9. Carbon Dioxide will liquify at 31° C. when pressurized to a minimum of 73.8 bar and will be and syphoned off from the high-pressure column through an outlet as shown in FIG. 6 in the 1^{st} stage cooler or first chamber 31. It is important to syphon off the liquid Carbon Dioxide before it cools down to below −56.6° C. and becomes solid (ice). Methane and oxygen will liquify at respectively −82.6° C. and −118.6° C. at minimum 50.4 bar and will be and syphoned off from the high-pressure column through another outlet or two further separate outlets as shown in FIG. 1 in a 2^{nd} and usually 3^{rd} cooling stages. Nitrogen may be cooled to −147° C. and removed as a liquid in a 3^{rd} or 4^{th} cooling stage and directed to the second housing. The cooling chambers for each stage are shown in FIG. 6 in a 4-stage cooler as chambers 31, 33, 35, and 37 and are described in more detail below.

Once it leaves the nitrogen rejection unit, liquid carbon dioxide is heated up to from 10° C. to 80° C. turning it to gas and increasing the pressure to 20 bar before being passed through an expansion valve to the reaction unit, reducing the temperature and pressure to a temperature of 20° C. at 1 bar. In the reaction unit it is mixed with artificial brine having the same temperature and pressure (20° C. and 1 bar).

The reactor unit may be a continuous tubular reactor as shown, however the shape of the housing within which reactions to convert carbon dioxide to carbonate take place is not limited to any particular shape. The housing must be able to contain the reactants at the desired temperature and pressure and must include inlets for reactants and outlets for products. Alkaline brine and the catalysts required for the hydrogenation reaction are fed from a feed tank 2 held at between 10° C. and 30° C., more preferably between 15° C. and 25° C. and more preferably at around 20° C. and at a pressure of between 0.5 and 2 bars and preferably at 1 bar of pressure. The tubular reactor 1 is also held within the same above ranges of temperatures and pressures as the feed tank 2 and is preferably held at the same temperature and pressure as the feed tank 2.

Within the tubular reactor, the following reactions take place if calcium is used:

CO₂ (g)+CaCl₂×2H₂O (l)+2NaOH (l)→CaCO₃ (s)+3H₂O (l)+2NaCl (l)

The alkaline brine may be from desalination or may be artificially produced. In the example shown, a catalyst (which may comprise nickel nanoparticles), sodium chloride, and calcium are added to water (some of which may be produced in drying slurry formed in one or more of the desulphurization unit or the reactor unit) and transported to the brine feed tank. Some additional fresh water may need to be added along with the waste water to achieve the desired consistency. The concentration of NaCl may, in some embodiments, be between 0.005 mol/litre and 0.05 mol/litre, preferably 0.02 mol/litre of the water. The ratio of brine (including catalysts and cations) to CO₂ within the tubular reactor should be maintained at between 3:1 and 5:1, preferably at around 4:1. This can be done by monitoring the rate of flow of the flue gas or of the material passing into the reactor unit at the inlet and adjusting the flow rate of material from the brine feed tank to the reactor unit accordingly. This could be achieved, for example, by adjusting the operation of a pump moving fluid from the brine feed tank to the tubular reactor in response to sensors measuring a flow rate either of the flue gas entering the system or of the material at any point within the apparatus prior to it reaching the inlet to the reactor tank.

Again, this method includes reuse of waste products for other means, improving efficiency and reducing cost of implementing the process. Mixing of the elements within the feed tank 2 may be aided by mechanical mixing means, an example of which is shown in FIG. 3 and indicated with numeral 13.

One of the products of the reactions occurring in the reactor unit in a case where calcium ions are present is calcium carbonate slurry. Some (for example between 80% and 95%) of this slurry may be dried out, preferably using a centrifugal dryer 15 as shown at between 15° C. and 25° C., preferably at 20° C., and at a pressure between 0.5 bar and 2 bar, preferably at 1 bar pressure. Water removed from the slurry can be redirected, possibly through one or more filters to ensure that the water does not contain additional particulates, and can flow back to the feed tank to be added to the brine held therein.

The calcium carbonate resulting from the drying step represents a useful commercial product and can be stored or sold in order to recoup some of the money used to implement the system. A portion of the calcium carbonate slurry may be transported from the reactor where it is formed to the spray tower to be used in the desulphurization process. In embodiments, between 3% and 20%, and preferably between 5% and 10%, of the calcium carbonate slurry produced in the reactor unit is transported to the spray tank for reuse in the desulphurization process (and the rest dried and the commercial grade calcium carbonate transported for sale or use).

All of the calcium carbonate slurry required for the desulphurization process can therefore be sourced from the output from the reactor unit. This way, calcium carbonate does not need to be sourced, paid for, and transported to the plant, which further increases the efficiency of the process. There is a level of synergy between the use of a solid metal catalyst and re-use of carbonate slurry formed as a result of the catalysed reaction in the desulphurization. The conversion rate from carbon dioxide to calcium carbonate required to supply the desulphurization process with sufficient amounts of calcium carbonate slurry can be obtained by the use of a solid metal catalyst, thus the increase in the efficiency of the whole process achieved by using both techniques is greater than sum of the individual increases in efficiency which would be achieved by the use of each technique alone.

FIG. 2 shows a perspective view of an apparatus for carbon capture. The figure is simplified and excludes various components, such as check and gate valves, pipe supports, and process sensors, all of which will be present in an embodiment. The apparatus here includes four tubular reactor tanks fed by four brine feed tanks. A reactor unit, therefore, may comprise two or more reactor tanks, just as the desulphurization unit may comprise two or more spray towers. A number of brine feed tanks may be present to form a brine feed unit. Two vacuum belt dryers 17 are included along with two screw separators 15 in the example shown, which receive calcium carbonate slurry from the reactor tank(s) and remove the water therefrom. An alternative simplified design uses only centrifugal separators to separate the water from the calcium carbonate. These centrifugal separators use gravitational and/or centrifugal force to separate out the liquid from the calcium carbonate in the calcium carbonate slurry. Electromagnets may be installed, for example in the inlet leading to the centrifugal separator or to the vacuum dryer/screw separator, to capture metal catalyst particles for re-use in the conversion process. Such electromagnets (or other means for separating out a catalyst from waste material leaving the reactor unit) can be used in any system. If magnetic means are used, these can be used in any system where solid metal or other magnetic catalysts are used. Because the catalyst particles are formed from solid metal, these are attracted to the magnets and captured for transport back to the brine feed tank or back to the reactor unit.

The number of tanks, separators, and/or dryers is not fixed. Although in the figure, one brine feed tank is connected to and feeds brine to one reactor tank, this also need not be the case and one of the feed tanks may feed brine to two or more of the reactor tanks if desired. The decision as to how many tanks of each type are required will be based largely on a balance of the cost with the required capacity of the system. Pipes carry flue gas, which has been mixed with the alkaline brine to the reactor unit for mineralisation. Additional inlets into the separators are at the base in this case and are not visible in the figure. Some of the slurry output from the reactor unit passes through the dryers and screw separators or the centrifugal separator and the extracted water is transported back to the brine feed tank through pipes. The screw separator or the centrifugal separator will each provide enough pressure to force the extracted water back into the brine feed tank. Commercial grade calcium carbonate is output as a product.

FIG. 3 shows cross sections of a tubular reactor (left) and a brine feed tank (right). The tanks are each cylindrical in the examples shown but need not be so provided that they can sufficiently contain the reactants and products as required. The tubular reactor tank includes a water vapour outlet, which may help to prevent any unwanted increase in pressure. The tubular reactor tank also includes a Pressure Safety Valve which will release the pressure in the reactor tank at a set pressure, in the event of excessive pressure from any of the inlets (carbon dioxide or brine). The water vapour can be transported back to the flue gas chimneys or can be released directly from the top of the reactor tank without being reincorporated in the system. The brine feed tanks include one or more inlets for waste water extracted from the CaCO₃ slurry after mineralization of carbon and for the brine and catalyst components and outlets for drainage and to carry brine and catalyst to the tubular reactor unit. The feed tanks each contain an electrical mixer 13 powered by a motor and comprising several sets of spinning arms to aid mixing of the component prior to transport to the reactor unit.

Pumps can be included in the system and these function to move material between the units. A large capacity pump, for example, can be used to move brine from the brine feed tank and into the reactor unit.

The housings for the brine feed tank, tubular reactor, and spray tank (if present) as well as the tubes carrying material between the tanks or units are preferably manufactured completely or partially from stainless steel. A typical reactor tank may be upwards of 15 feet high (around 20 ft high) which may necessitate construction of the apparatus on-site near to the power plant. Supply and return pipelines, transporting flue gas from the power plant and waste products from the power plant, may also be formed from stainless steel. Additional structure or frames, which may again be formed from stainless steel, can be used to protect the reactor tanks, as well as the brine feed tank and spray tank if required.

The process shown in FIG. 1, and described above, adds additional efficiency to the carbon capture procedure and reduces costs in two ways. Firstly, use of a solid metal catalyst to increase the rate of hydrogenation of the carbon dioxide within the tubular reactor means that the whole process can happen quicker, which of course means that pumps, condensers, heaters, and so on do not need to be operated for such long periods. This greatly saves on running costs.

Secondly, the process includes the reuse of waste or output products of sub-processes as input to other sub-processes within the overall system. FIG. 4 is a flow chart omitting some parts of the process but illustrating in particular the idea of reusing the output of one sub-process or unit as the input to another.

There are three main parts of the system which capitalise on the possibility of recycling what would traditionally be considered as a waste product. Rather than these substances simply being disposed of or put to other unrelated uses, they are re-used within the system itself. The choice of the combination of reactants used for each of the units or sub-systems (the reactor unit, brine feed tank, nitrogen rejection unit, and desulphurization unit in an example) facilitates this recycling of products because the outputs to certain of these units are also the inputs to other parts of the system where possible. One, two, or all of these recycling processes can be used within any particular system.

Water that is passed into the feed tank and used to form the brine which supports hydrogenation and mineralisation of the carbon dioxide is sourced from the output of one or more of the desulphurization unit and the reactor unit. Although some water may be sourced externally if required, at least some and potentially most or all of the water input to the feed tank is extracted during drying of the output from the desulphurization unit to form gypsum, and/or extracted during drying of the slurry that is output from the reactor to form calcium carbonate. This extracted waste water may be filtered before being passed back into the feed tank as shown. In order that the dried calcium carbonate meets requirements in terms of quality for commercial sales, a large capacity vacuum plate dryer or a centrifugal dryer may be required to properly extract water from the slurry which is output from the reactor tank.

Some of the calcium carbonate slurry, which is the product of reactions taking place within the reactor, is not disposed of but is directed back to the spray tower and used in the wet scrubbing process for the removal of SO₂ from the flue gas entering the system.

Additional, external, sources of water and calcium carbonate slurry may be included for input to the feed tank and the desulphurization unit, although these may not (and generally will not) be required. These additional input means can also be used if waste products are not being produced at the rate required, for example during start-up of the system if there is a lag between switching on of the system and the start of production of waste products from later sub-processes which are recycled for use in earlier processes, such as the output from the tubular reactor section which is reused in the desulphurisation step.

The nitrogen rejection unit 5 will now be described in more detail. The apparatus uses cryogenic distillation to separate out the various constituents of the gas. This works particularly well within the overall system for carbon capture described herein because of the need to extract CO₂ for input to the reaction chamber. Other gases are also syphoned off and can be stored or transported for use. Methane, as mentioned, can be a useful additive for biofuels and liquid nitrogen is used widely for cooling. Although the apparatus is particularly suitable for use in the carbon capture system described herein, the nitrogen rejection unit 5, including high pressure column 9 and low-pressure column 11, can be used in any carbon capture process where a gas is required to be separated into its component parts. The system can indeed be used anywhere that nitrogen needs to be extracted from a gas and the constituents of the gas separated out.

The nitrogen rejection unit 5 is illustrated in FIG. 5. The input shown is flue gas, treated to remove ash, NOₓ and SOₓ as described above. As mentioned, the input may be any nitrogen containing gas. Other liquid substances in addition to methane and carbon dioxide may then be syphoned from the high-pressure column once they have become liquid.

In this case, the gas input into the system or sub-system is treated flue gas containing gaseous nitrogen, oxygen, methane, carbon dioxide, and water (which may be in the form or water vapour). This gas passes first through a dryer 19, which may be a condensing heat exchanger, within which water vapour is removed from the gas. The dry gas now containing nitrogen, oxygen, methane and carbon dioxide, is passed to a compressor 21 which increases the pressure of the gas, such as to around 100 bar to 300 bar, preferably 100 bar to 200 bar, and most preferably to 150 bar, before passing it into the high-pressure column. The appropriate one-way valves are included (not shown) in order to maintain material within the high-pressure portions when desired. Additional pumps may also be used to move materials between and through parts of the system and these are also not shown. Where pressure is referred to, this refers to the pressure produced by the mix of gases and liquids that will be within the tanks, chambers, or vessels including pipes and valves in the process. The pressure will remain relatively constant for each tank or vessel, including the high and low-pressure columns of the nitrogen rejection unit throughout the process.

Within the high-pressure column 9 the gas, held at between 5 bar and 300 bar, preferably at between 100 bar and 200 bar, more preferably at between 130 and 170 bar, and most preferably at around 150 bar, is cooled using liquid nitrogen circulated through the column down to a temperature of between −140° C. and −160° C., preferably between −145° C. and −155° C., most preferably at around −150° C. The temperature within the high-pressure column will vary depending on the position within the column, as will be described in more detail below, but the above values will represent the temperature of the coolest material within the high-pressure column. The cooling will take place in four sequential cooling chambers (shown as chambers 31, 33, 35, and 37 in FIG. 6), the 1^{st} stage cooler will cool the gas down to 10° C., which will liquify carbon dioxide and allowing it to be syphoned off. The 2^{nd} stage cooler will cool the gas within the second chamber 33 down to −85° C. liquifying methane and allowing this to be syphoned off, and the 3^{rd} stage cooler will cool the remaining gas down to −125° C., liquifying oxygen and allowing it to be syphoned off, and the fourth stage cooler will liquify the remaining nitrogen by cooling it down to −150° C. This is below the temperature at which carbon dioxide becomes solid (ice) at the pressure of the column. The three-stage cooling process will turn all of the methane, carbon dioxide, and oxygen in the flue gas into liquid form, which can then be easily extracted from one or more outlets. These outlets will generally be at or near to the base of the separate chambers of the high-pressure column. If two species are removed from the same chamber in liquid form then in order to separate the extracted materials, the temperature of the liquid outlet from the high-pressure column of the nitrogen rejection unit is increased incrementally so that the vaporization temperature of each of the gases therein is passed in turn allowing these to be outgassed separately from one another. Alternatively, different outlets can be used at different heights depending on the density of each liquid. Rather than four separate cooling chambers being present, one, two, or three chambers can be present and two or more of carbon dioxide, methane, and oxygen can be syphoned off together from a single chamber. A first chamber can be used to cool the material to 10° C. to liquify carbon, and a second chamber to cool the remaining gas to −125° C. to liquify and remove methane and oxygen, for example. Four separate chambers to liquify carbon dioxide, methane, and oxygen in turn is however very efficient.

After the cooling process is complete, liquid nitrogen is transported from the high-pressure column 9 to the low-pressure column 11 through an outlet, which may generally be located at or near to the top of the high-pressure column. As the nitrogen passes from the high-pressure column to the low-pressure column it expands, and energy from the expansion drives a non-combustion turbine which is used to drive the compressor 21. The compressor acts to increase the pressure of the gas entering the nitrogen rejection system. An expansion turbine or turboexpander 23 may be used for this purpose. A turboexpander, also referred to as a turbo-expander or an expansion turbine, is a centrifugal or axial-flow turbine through which a high-pressure gas or material is expanded to produce energy. In this case, this energy can be used to at least partially drive the flue gas compressor. The turboexpander may be a cryogenic turboexpander, meaning that it is designed in such a way as to be able to withstand temperatures down to minus 200 degrees Celsius.

The nitrogen is cooled further by expansion in the turboexpander to a temperature of between −200° C. and −190° C., more preferably between −198° C. and −194° C., and most preferably around −196° C. The nitrogen will still be in its liquid form. Rather than including separate cooling means or using nitrogen that is sourced externally, the nitrogen from the flue gas (which is now liquid nitrogen) is recycled and used as cooling fluid for the high-pressure column by passing it through one or more tubes 25 running into and through or around the high-pressure column. Excess liquid nitrogen is syphoned off and away from the system for storage or use elsewhere. Clearly, the structure of these cooling tubes is important, and a high surface area is desired for heat transfer. Thin, long, and winding tubes may be used, or even a plate structure within the high-pressure column through which liquid nitrogen is passed.

FIG. 6 shows the high-pressure and low-pressure columns (9 and 11) of the nitrogen rejection unit in more detail. The nitrogen rejection unit in this case is a system for the removal of carbon dioxide, methane and oxygen from flue gas. Dry flue gas, after being compressed in an axial compressor (A; 21) to between 100 and 200 bar, is passed to a nitrogen rejection unit comprising each of a high-pressure distillation column (B; 9) and low-pressure column (C; 11). Phase changes occurring in the high-pressure column 9 of the nitrogen rejection unit are as follows:

N₂ (g)+O₂ (g)+CO₂ (g)+CH₄ (g)→N₂ (l)+O₂ (l)+CO₂ (l)+CH₄ (l)

Methane, oxygen, and carbon dioxide are liquified in the high-pressure column and syphoned off away from the nitrogen rejection unit, and in some cases to separate storage tanks.

Within the high-pressure column 9, the compressed flue gas, held at between 100 and 200 bar, and preferably at around 150 bar, is cooled down using liquid nitrogen as a cooling medium in a tubular heat exchanger. In a first distillation/cooling chamber 31 carbon dioxide gas is cooled down to 10° C., at which point it turns to a liquid and is syphoned off to a separate storage tank. In a second distillation/cooling chamber 33 methane gas is cooled down to −85° C., at which point it turns to a liquid and is syphoned off to a separate storage tank. In a third distillation/cooling chamber 35, oxygen gas is cooled down to −125° C., at which point it turns to a liquid and is syphoned off to a separate storage tank, the nitrogen is cooled further to −150 and is itself syphoned off as a liquid and transported to the low-pressure column. The temperatures can be different to those listed above (although if the above temperatures are used then a very efficient distillation process can be achieved). The temperature to which material in the first chamber 31 is cooled should be at or below 31° C. and above −82.6° C. so that carbon dioxide is liquified but methane, oxygen, and nitrogen remain in their gaseous form. The temperature to which material in the second chamber 33 is cooled should be at or below −82.6° C. and above −118.6° C. so that methane is liquified, but oxygen and nitrogen remain in their gaseous form. The temperature to which material in the third chamber 35 is cooled should be at or below −118.6° C. and above −147° C. so that oxygen is liquified and nitrogen remains in its gaseous form, and the temperature to which material in the fourth chamber 37 is cooled should be at −147° C. or below if nitrogen is to be liquified. If nitrogen is to be removed in its gaseous form from the first housing, then no further cooling is required in the fourth chamber.

In an alternative example, the first housing can be kept at a higher pressure of around 25 bar, and the temperatures in the chambers can be −40° C., −162° C., −184° C., and −184° C. respectively. No further cooling occurs in the fourth chamber in this case, and nitrogen is removed from the first housing as a gas and liquifies as it cools on expanding between the first and second housing.

Mesh pads 27 are positioned between the distillation chambers (in this case four cooling chambers 31, 33, 35, and 37 are present in the high-pressure column, with three mesh pads separating the four chambers). These prevent the liquid, which should be syphoned off from each of the chambers at an outlet, from entering the adjacent chambers. The mesh pads 27 do, however, need to be configured to allow gaseous substances to pass through into the adjacent chamber (in this case the chamber above), for further cooling. The orientation of the columns is not critical and can be adapted, for example, so that the cooling chamber for carbon dioxide is located at the top of the tank and gases travel from an inlet at the top of the column towards the bottom in the opposite direction to the flow of gas in the system shown in FIG. 6. Movement of the gases from one chamber to the next may be active (i.e. using a pump or another mechanism) or passive. This movement may occur simply as a result of additional gas, which is continuously entering the high-pressure housing through an inlet, forcing the rest of the material through the system.

In the top chamber 37, nitrogen is liquified and this is transported from the high-pressure column 9 to the low-pressure column 11 through an outlet. As the nitrogen passes from the high-pressure column to the low-pressure column 11 it expands (i.e. through a turboexpander or expansion turbine 23) and cools down to −196° C. as a result of the expansion. Using the expansion turbine, energy from the expansion process is used to drive the compressor 21, which acts to increase the pressure of the gas entering the nitrogen rejection system. The cooling of the nitrogen to the temperature of the second housing may be entirely due to its expansion, or additional cooling means may be used.

Rather than including separate cooling means to reduce the temperature of the material in the first housing, or using nitrogen that is sourced externally, the nitrogen from the flue gas (in the form of liquid nitrogen) is recycled and used as cooling fluid for the high-pressure column by passing it through tubular heat exchangers, around or in and out of the high-pressure column. At least some, if not all, of the liquid nitrogen in the low-pressure column is used for cooling of the high-pressure column. However, not all of the liquid nitrogen necessarily needs to be routed through the heat exchanger of the high-pressure column, and some may be syphoned off for other uses, removed from the system, or stored for later use in the same cooling systems.

In order to achieve the specific temperatures required for liquifying carbon dioxide, methane, oxygen, and nitrogen cryogenic pumps regulated by temperature sensors are used to provide the correct flowrate of liquid nitrogen through the independent tubular heat exchangers in each of the distillation chambers (31, 33, 35, and 37). These temperature sensors are indicated as parts 29 in FIG. 6, and each is configured to measure the temperature of the contents of one of the chambers 31, 33, 35, and 37 either directly or indirectly. Each sensor 29 may also be coupled to a pump for cycling liquid nitrogen from the low-pressure column and through or around the respective chamber for cooling. Each cooling chamber may therefore have a dedicated cooling system comprising conduits for carrying liquid nitrogen from an outlet from the low-pressure column, around and/or through the cooling chamber, and back to the low-pressure column. In some embodiments, at least some of the cooling fluid may be syphoned off from the system after passing through the cooling system, and this may be used as the outlet for excess liquid nitrogen described above.

Where four cooling stages are included, four separate cooling systems may be provided to carry liquid nitrogen from the low-pressure column towards and through and/or around the different chambers of the high-pressure column. The number of cooling systems, each including a surface for heat exchange through or past which liquid nitrogen can flow, and preferably also a temperature sensor and a pump for regulating the temperature of the chamber, will correspond to the number of cooling stages or cooling chambers. The heat exchanger for transfer of heat from away from the high-pressure column for cooling can thus consist of three parts, each of which is configured to cool one of the chambers, and each of which is coupled to its own outlet from the low-pressure chamber. The heat exchangers may comprise networks of passages through and/or around each cooling chamber.

As mentioned, each of the outlets can be provided with a pump controlled in response to a temperature sensed by the temperature sensor. If the material within the cooling chamber associated with the pump is determined to be above a threshold temperature, feedback can be provided to increase power to the pump in order to increase the flow rate for the cooling fluid. This will then increase the cooling rate for that chamber to decrease the temperature of the material therein. Conversely, if the temperature is measured to be below a threshold value, feedback can be provided to change operation of the pump to decrease the flowrate and increase the temperature of the material in the chamber. The thermometer and pump combination can therefore act as a type of thermostat. The thresholds may represent the limits of a range of temperatures or may correspond to a particular value, with constant feedback provided as the temperature in the chamber fluctuates around this value. This value may be 10° C. for the first chamber 31, −85° C. for the second chamber 33, −125° C. for the third chamber 35, and −150° C. for the fourth chamber 37. If three chambers are provided, this value may be approximately 10° C. for the first chamber, approximately −125° C. for the second chamber, and approximately −150° C. for the third chamber. If a range of temperatures is allowed, then the threshold temperatures for that chamber may be around 5° C. below the values above and up to the condensation temperature for the material being distilled in that chamber or 5° C. above and below the target temperature in the case of the first chamber (e.g between 5° C. and 15° C. for the first chamber, between −82.6° C. and −90° C. for the second chamber, between −118.6° C. and −130° C. for the third chamber, and between −147° C. and −155° C. for the fourth chamber. The threshold temperatures will preferably be around 2° C. above the value above and down to the condensation temperature (or 2° C. above and below the target value in the first chamber), and most preferably from the condensation temperature to around 1° C. below the value listed above (and 1° C. above and below the target value for the chamber where carbon dioxide is being distilled). There may be no lower threshold temperature in some cases (as the system may be inherently incapable of decreasing the temperature below a certain value, or the pumps operating above a certain power level) and optionally the upper threshold may be the condensation temperature for each of the materials being distilled in each chamber.

Excess liquid nitrogen may be syphoned off and away from the system for storage or use elsewhere. Clearly, the structure of the cooling tubes within which liquid nitrogen travels around and/or through the chambers of the high-pressure column is important, and a high surface area is desired for heat transfer. Thin, long, and winding tubes may be used, or even a plate structure within the high-pressure column through which liquid nitrogen is passed.

Use of the expansion turbine to at least partially drive the compressor and recycling of the nitrogen in the flue gas as a coolant in the high-pressure distillation column are unique features, and provide particular advantages when used together within the same system. As a result of their inclusion, less energy is required to be input to the nitrogen rejection system and the efficiency of the overall process is increased. This lowers the operational cost of which is of paramount importance to companies seeking to reduce their carbon footprint using a process which remains commercially viable.

The overall system described is theoretically capable of converting 100% of the carbon dioxide present in the flue gas to carbonates, reducing the additional tax burden due to CO₂ emissions to zero. In addition, the carbonate product may be commercial grade calcium carbonate which can be sold for use in the building industry recouping at least some of the cost of implementing the carbon capture technology described above.

FIG. 7 illustrates the total mass balance of the process described above for a typical coal burning power plant. In this case numbers are based on the Belchatow power plant in Poland, which operates at 5035 MW (or at around 5000 MW). The numbers will vary depending on the size of each plant.

The following table illustrates the mass flow into the carbon capture apparatus for each of the constituent parts of the flue gas in a plant operating at around 5000 MW, such as Belchatow. The numbers provided in both the table and the figure are calculated on the assumption that 100% carbon dioxide mineralisation can be achieved. The mass flow in practice will be distributed across an array of apparatuses, each serving one combustion chamber within the plant. In the case of the Belchatow plant, in order to deal with the rate of production of CO₂ it will likely be necessary for two reactor tanks to be present serving each of the combustion chambers.

| Substance | qₘ (kg/min) |
|---|---|
| N₂ | 300 000 |
| H₂O | 83 100 |
| CO₂ | 60 000 |
| O₂ | 13 200 |
| SO₂ | 60 |
| NOₓ | 60 |
| CO | 60 |
| N₂O | 60 |
| CH₄ | 13 680 |
| Ash | 41 100 |

This following table lists ratios of mass flow for different substances. These values (unlike the absolute mass flow numbers in the table above) should not vary much between plants.

| | Ratio of Mass |
|---|---|
| Substance | Flow Values |
| N₂/CO₂ | 5 |
| H₂O/CO₂ | 1.385 |
| O₂/CO₂ | 0.22 |
| SO₂/CO₂ | 0.001 |
| NOₓ/CO₂ | 0.001 |
| CO/CO₂ | 0.001 |
| N₂O/CO₂ | 0.001 |
| CH₄/CO₂ | 0.228 |
| Ash/CO₂ | 0.685 |

The total process energy balance is shown in FIG. 8, again based on the Belchatow plant which has 13 combustion chambers. Numbers in the figure are calculated based on the following specific heat capacity measurement for each substance.

| | Specific heat capacity |
|---|---|
| Substance | cₚ (J/kg C.) |
| Flue gas | 1 243 |
| N₂ | 1 004 |
| H₂O | 4 200 |
| CO₂ | 750 |
| O₂ | 900 |
| SO₂ | 633 |
| NOₓ | 975 |
| CO | 1 047 |
| N₂O | 995 |
| CH₄ | 2 225 |
| CaCO₄ | 8 343 |
| CaSO₃ | 1 090 |
| Brine | 2 300 |

More than one carbon capture system, and preferably two such systems, may be installed to serve each of the combustion chambers in a power plant.

The carbon capture system described above is more efficient than prior solutions because of the improved cooling mechanism within the nitrogen rejection unit. In addition, aside from the use of solid metal catalysts to increase the speed of reactions occurring within the reactor sub-system, wherever possible waste substances and energy are recycled and used in other parts of the system. This is true in the case of the spray tower, where waste slurry from the reactor is used to remove SO₂ from incoming flue gas, in the case of the nitrogen rejection unit, where nitrogen extracted from the flue gas itself provides energy required for compression as it expands and is reused for cooling of the incoming gases. Waste water is also recycled where possible to produce the slurry that is input into the reactor.

1. A nitrogen rejection unit (5) for extracting nitrogen and carbon dioxide from a material, the unit comprising:
a first housing (9) comprising a first chamber for holding a first volume of the material at a first pressure and a first temperature that is below or equal to the condensation temperature of the carbon dioxide at the first pressure and greater than the condensation temperature of nitrogen;
an outlet for removing the carbon dioxide as a liquid from the first chamber of the first housing (9) and a pathway for gaseous nitrogen to pass into a second chamber of the first housing;
means for transporting nitrogen from the first housing to a second housing, wherein the second housing holds the nitrogen at a second temperature that is below or equal to the condensation temperature of nitrogen; and
a conduit for guiding liquid nitrogen from the second housing through and/or around the first housing to cool the material within the first housing to the first temperature.

2. A nitrogen rejection unit (5) according to claim 1, wherein the nitrogen expands as it passes from the first housing (9) to the second housing (11) such that material in the second housing is at a second pressure that is lower than the first pressure.

3. A nitrogen rejection unit (5) according to claim 2, wherein energy from the expansion of the nitrogen as it passes from the first housing (9) to the second housing (11) is used to compress the first volume of material entering the first housing.

4. A nitrogen rejection unit (5) according to claim 3, wherein the nitrogen passes through an expansion turbine (23) as it passes from the first housing (9) to the second housing (11), and the expansion turbine is configured to drive a compressor (21) for compressing the first volume of the material to the first pressure.

5. A nitrogen rejection unit (5) according to any of claims 1 to 4, wherein liquid nitrogen flows from the second housing (11), through and/or around the first housing (9) along a pipe (25) that forms a tortuous path, and then back to the second housing.

6. A nitrogen rejection unit (5) according to claim 2, wherein the material within the first housing (9) is held at a pressure between 100 bar and 200 bar and the material within the second housing (11) is held at a pressure between 25 bar and 75 bar.

7. A nitrogen rejection unit (5) according to any of claims 1 to 6, wherein the second temperature is around −196° C.

8. A nitrogen rejection unit (5) according to any of claims 1 to 7, wherein the first housing comprises at least two cooling chambers and the material within the first housing is cooled to the first temperature in a first chamber (31) and to a third, lower, temperature in a second chamber (33).

9. A nitrogen rejection unit (5) according to claim 8, wherein the first housing comprises four cooling chambers (31; 33; 35; 37) and the material within the first housing is cooled to the first temperature in the first chamber (31), to the third temperature that is between the first temperature and the second temperature in the second chamber (33), and to a fourth temperature that is between the third temperature and the second temperature in the third chamber (35), and to a fifth temperature that is between the fourth temperature and the second temperature in a fourth chamber (37).

10. A nitrogen rejection unit (5) according to claim 9, wherein the first temperature is 10° C., the third temperature is −85° C., the fourth temperature is −125° C., and the fifth temperature is −150° C., and wherein CO₂ is removed as liquid from the first chamber (31) of the first housing, methane is removed as a liquid from the second chamber (33) of the first housing, oxygen is removed as a liquid from the third chamber (35) of the first housing, and the nitrogen is transported as a liquid from the fourth chamber (37) of the first housing to the second housing.

11. A nitrogen rejection unit (5) according to any of claims 8 to 10, wherein each cooling chamber (31; 33; 34; 37) is provided with a separate cooling system comprising an outlet for liquid nitrogen from the second housing (11) and one or more conduits for liquid nitrogen to flow from the outlet in and/or around the cooling chamber.

12. A nitrogen rejection unit (5) according to any of claims 1 to 11, wherein the temperature of the material within the first housing (9) is regulated by adjusting the flow rate of the liquid nitrogen through and/or around the first housing.

13. A nitrogen rejection unit (5) according to claim 12 when dependent from claim 11, wherein each cooling system comprises a temperature sensor (29) for measuring a temperature of the material within the chamber (31; 33; 34; 37) and a pump for moving fluid from the outlet and through the one or more conduits, wherein the action of the pump is controlled in response to a temperature measured by the temperature sensor (29) to maintain the temperature of the material in the chamber (31; 33; 34; 37) within a pre-determined range of temperatures.

14. A method for extracting nitrogen from a gas comprising nitrogen and carbon dioxide, the method comprising:
compressing, using a compressor (21), a volume of the gas to a first pressure, transferring the volume of gas to a first chamber (31) of a first housing (9), and cooling it to a first temperature that is below or equal to the condensation temperature of carbon dioxide and greater than the condensation temperature of nitrogen;
removing the carbon dioxide as a liquid from the first chamber (31) of the first housing (9);
transporting the nitrogen or allowing the nitrogen to pass as a gas from the first chamber to a second chamber (33) of the first housing (9);
transporting the nitrogen or allowing the nitrogen to pass from the first housing to a second housing (11) where it is at a second pressure and a second temperature which is below the condensation temperature of nitrogen at the second pressure;
removing liquid nitrogen from the second housing (11) and passing at least some of the liquid nitrogen from the second housing (11) through or around the first housing (9) to cool the material therein.

15. The method according to claim 14, wherein the nitrogen is passed from the first housing (9) to the second housing (11) through an expansion turbine (23) such that it reaches a second pressure that is lower than the first pressure, and wherein the expansion turbine (23) is used to drive the compressor (21).
